(19) United States
(12) Patent Application Publication
(10) Pub. No.: US 2012/0321816 A1
(43) Pub. Date: Dec. 20, 2012

(54) SYSTEMS AND METHODS FOR LEVELING INKS

(75) Inventors: Naveen Chopra, Oakville (CA); Michelle N. Chrétien, Mississauga (CA); T. Brian McAneney, Burlington (CA)

(73) Assignee: XEROX CORPORATION, Norwalk, CT (US)

(21) Appl. No.: 13/160,416

(22) Filed: Jun. 14, 2011

(51) Int. Cl. B01J 19/08; B41J 2/015

(52) U.S. Cl. 427/560; 347/20

(57) ABSTRACT

Methods for leveling phase change gel inks are disclosed. More particularly, the methods employ ultrasound irradiation to level the phase change gel inks in a non-contact manner. Phase change gel inks are relatively new inks characterized by being a gel-like consistency at room temperature and a low viscosity liquid at an elevated temperature for jetting on a substrate. Due to these unique properties, conventional methods of leveling gel inks have failed. Also disclosed are systems which implement the methods described herein.

### BACKGROUND

The present embodiments relate to phase change ink compositions that can be used for ink jet printing in a variety of applications. A relatively new type of phase change ink is an ultraviolet (UV) curable gel ink. An UV curable gel ink is characterized by being a gel-like consistency at room temperature and a low viscosity liquid at an elevated temperature for jetting on a substrate. When the ejected ink hits the substrate, it changes phase from the liquid back to its more viscous gel consistency. Because the gel inks solidify rapidly upon cooling, these inks have advantages over water or solvent-based inks that may de-wet from many surfaces, such as plastics, cardboard, and the like. Once the gel ink is exposed to UV radiation, the ink is cured to form a cross-linked polymer matrix resulting in a very hard and durable mark on the substrate.

There remains a desire to level or spread the ink to reduce the so-called “corduroy” effect and achieve more uniform gloss, mask missing jets, and thinner layers required for applications such as packaging. Conventional leveling methods and devices, however, cannot be used with the gel inks due to their unique properties. Since these inks have a paste-like consistency, the inks have very little cohesive strength prior to curing. In addition, the inks are designed such that they have good affinity to many materials. Due to this fact, conventional methods for flattening a layer of ink tend to fail when used with the UV gel ink because the ink will stick to the leveling device and undergo cohesive failure (i.e. splits) leaving residual ink behind on the leveling device. It is not possible to flatten the ink after it has cured either because the polymerized material is extremely tough and non-yielding.

Ampo, K. et al. “Leveling Viscous Fluids Using Ultrasonic Waves”. JJAPS, (2004), vol 43, pp 2857-2861 describes a method for leveling viscous fluids, in this case a photoresist material, on substrates using ultrasound techniques. In this paper, it has been proposed that such a method may be advantageous over traditional coating methods such as slit nozzle methods (due to unevenness and orientation dependence), and spin-coating (challenging for large substrates and wasteful, due to spilling off of the edges). The paper describes experiments done to level a photoresist material with a viscosity of 10 cps coated onto a non-porous substrate. However, this paper does not address how one could level a viscous gel ink (with viscosity of 10⁶ cps). Moreover, there is no teachings in this publication on how one would level a viscous gel ink on a substrate such a paper.

U.S. Pat. No. 5,376,402 which is hereby incorporated by reference herein in its entirety, describes, in embodiments, an ultrasonically assisted coating method for applying a smooth layer of coating material on a surface of a moving web. In this patent, the coating material is deposited using a die onto a moving web, where the ultrasonic energy generator is applying ultrasonic energy in a variety of modes, directly to the web, to the die itself, and through the air. However, this patent only describes materials deposited by ‘contact’ approaches, such as slot-fed knife coating, roll-coating, and extrusion coating. Furthermore in the single example cited in the patent, the highest viscosity material tested was a solvent-based rubber coating with a viscosity of 5,000 cps, at a thickness of 63.5 um. Thus, this reference does not address how one would level a viscous gel ink on a substrate.

Thus, there exists a need for a non-contact approach to level the images printed with gelled UV inks prior to curing. The present embodiments are thus directed to curable gel inks, and more particularly, UV curable gel inks and methods specially adapted for leveling these inks on substrates.

### SUMMARY

According to embodiments illustrated herein, there is provided a method for leveling a phase change gel ink comprising: applying the phase change gel ink on a substrate to form an unleveled ink film; and subjecting the unleveled ink film to ultrasound irradiation to form a leveled ink film.

In particular, the present embodiments provide a system for leveling a phase change gel ink comprising: a print head for transferring the phase change gel ink to a substrate to form an unleveled ink film; a leveling device for subjecting the unleveled ink film to ultrasound irradiation to form a leveled ink film; and a curing station for curing the leveled ink film.

In further embodiments, there is provided a system for leveling a phase change gel ink comprising: an inkjet print head for jetting the phase change gel ink to a print substrate to form an unleveled print image; a leveling device for subjecting the unleveled print image to ultrasound irradiation to form a leveled print image; and a curing station for curing the leveled print image.

### BRIEF DESCRIPTION OF THE DRAWINGS

For a better understanding of the present embodiments, reference may be had to the accompanying figures.

FIG. 1 is a flowchart illustrating a method for leveling phase change gel inks according to the present embodiments;

FIG. 2 is a schematic illustrating a printing system that employs the methods for leveling according to the present embodiments; and

FIG. 3 illustrates complex viscosity versus temperature for an exemplary ink.

### DETAILED DESCRIPTION

In the following description, it is understood that other embodiments may be utilized and structural and operational changes may be made without departure from the scope of the present embodiments disclosed herein.

Phase change ink technology broadens printing capability and customer base across many markets, and the diversity of printing applications will be facilitated by effective integration of printhead technology, print process and ink materials. The phase change ink compositions of the present embodiments are characterized by being a gel at room temperature and a liquid at elevated jetting temperatures. As discussed above, after the ink is applied to a substrate, the ink needs to be leveled or spread to reduce the “corduroy” effect and to achieve a more uniform and consistent image. Because the gel inks have very little cohesive strength prior to curing and good affinity to many materials, conventional methods for flattening a layer of ink after application tend to fail when used with the UV gel inks. Thus, the present embodiments present a non-contact approach to level the gel inks prior to curing. In particular, the present embodiments are directed methods of leveling gel ink prints without physical contact but rather through the use of ultrasound waves. Gel inks which can be leveled with the present methods are disclosed in U.S. Pat. Nos. 7,153,349, 7,259,275, 7,270,408, 7,271,284, 7,276,614, 7,279,506, 7,279,587, 7,293,868, 7,317,122, 7,323,498, 7,384,463, 7,449,515, 7,459,014, 7,531,582, 7,538,145, 7,541,406, 7,553,011, 7,556,844, 7,559,639, 7,563,489, 7,578,587, 7,625,956, 7,632,546, 7,674,842, 7,681,966, 7,683,102, 7,690,782, 7,691,920, 7,699,922, 7,714,040, 7,754,779, 7,812,064, and 7,820,731, which are hereby incorporated by reference in their entireties. Generally, UV curable gel inks comprise blends of, waxes, resins, monomers, curable waxes, optional colorants, free-radical photoinitiators, and optional additives, such as stabilizers, viscosity modifiers, and dispersants.

The use of ultrasonic waves for leveling methods are known, for example, as disclosed in U.S. Pat. No. 5,376,402 and Ampo et al., Leveling Viscous Fluids Using Ultrasonic Waves, Japanese Journal of Applied Physics, Vol. 43, No. 5B, 2004, pp. 2857-2861, which are hereby incorporated by reference in their entireties. Such use, however, has never been proposed for Use in leveling printed images.

In specific embodiments, the UV curable gel ink may be applied by jetting with an inkjet printer at a specific jetting temperature. It is desired for the UV curable gel inks to have a viscosity of less than about 50 mPa-s, such as less than about 30 mPa-s, for example from about 3 to about 30 mPa-s, from about 5 to about 20 mPa-s or from about 8 to about 15 mPa-s, at the temperature of jetting of the ink. Thus, the inks are jetted in a liquid state, which is achieved by applying heat to melt the ink prior to jetting. The inks are desirably jetted at low temperatures, in particular at temperatures below about 120° C., for example from about 50° C. to about 110° C. or from about 80° C. to about 110° C. The ink may have a viscosity of at least 10³ mPa-s at lower temperatures, for example, from 10⁴ mPa-s to about 10⁹ mPa-s at a temperature of from about 20° C. to about 60° C.

In the present embodiments, a gel ink is deposited on a substrate. In embodiments, the gel ink is applied in a layer having a thickness of from about 0.5 to about 100 μm, or of from about 1 to about 50 μm. The layer of deposited gel ink is subsequently subjected to ultrasound irradiation from an ultrasonic transducer or any an apparatus capable of generating ultrasound waves. In specific embodiments, the source of the ultrasound irradiation can selected from sources such as those disclosed in U.S. Pat. No. 5,276,402, for example, a resonant sontrode or ultrasonic horn.

The strength of the ultrasound irradiation can vary depending on the amount of leveling desired and properties of the gel ink. It is known that more viscous systems require lower frequencies and greater peak-peak amplitudes. As such, the gel inks of the present embodiments may be leveled with low frequency ranges and wide peak-peak amplitude. In embodiments, the ultrasonic conditions comprise from about 0.002 to about 0.60 mm, or from about 0.01 to about 0.50 mm peak-peak amplitude and a frequency of from about 20,000 to about 100,000 Hz, or from about 20,000 to about 30,000 Hz. For example, an unleveled material having a viscosity of up to about 5,000 cPs can be leveled under ultrasonic conditions of 0.03 mm peak-peak amplitude and a frequency of 20,000 Hz.

In some instances, where the viscosity is so high that ultrasonic energy alone is insufficient to obtain the desired leveling effect, it is also possible to re-heat the ink to some degree to reduce the viscosity. For example, one may want to heat the ink to a temperature just below the gel point, so as not to induce soak-through into the page, but to a point where the viscosity is low enough to use low amplitude ultrasound waves to enable leveling.

The ultrasonic energy intensity I, is a function of

l=cπ²ρₒf²xₒ

wherein ρₒ is the density of the medium, f is the frequency of the acoustic wave, and xₒ is the peak-peak amplitude. In embodiments, the ultrasound irradiation has an intensity of from about 5 to about 100 W, or from about 10 to about 50 W. In a particular embodiment, the ultrasound irradiation is from a 25 W ultrasound horn. The gel ink can be leveled by both standing wave and traveling waves.

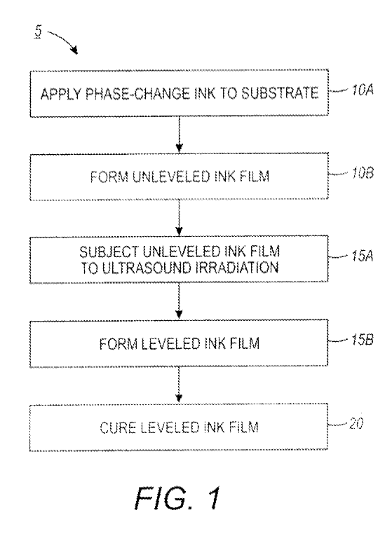

FIG. 1 is a flow chart illustrating a method for leveling 5 according to the present embodiments. As shown, the method generally comprises applying the phase change gel ink, such as a UV curable gel ink, on a substrate 10A to form an unleveled ink film 10B, and subjecting the unleveled ink film to ultrasound irradiation 15A to form a leveled ink film having a uniform thickness 15B. In embodiments, the uniform thickness is from about 1 to about 100 μm, or from about 1 to about 50 μm. The unleveled ink film may be subjected to the ultrasound irradiation for about 0.1 to about 300 seconds, or for about 0.1 to about 60 seconds. The method can further include curing the leveled ink film 20. In embodiments, the phase change gel ink is applied by a print head such as, for example, jetting from an inkjet print head. In embodiments, the ink film is a printed image.

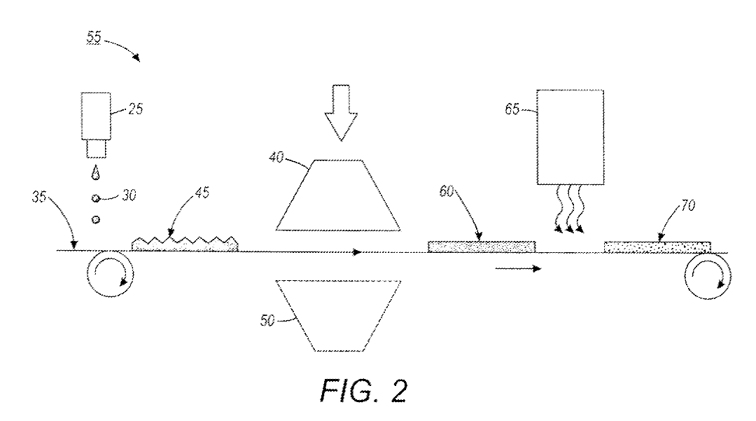

FIG. 2 illustrates a printing system that employs the methods for leveling according to the present embodiments. In FIG. 2, the printing system 55 has a print head 25 that transfers ink 30 to a substrate 35, like print media. The print head 25 may be a digital, electronically addressed print head such as in an ink jet printer, in which ink is dispensed via an array of nozzles from an ink reservoir. While continuous web architecture is shown in FIG. 2, the present leveling methods can be applied to both cut sheet or continuous web architectures. The representation of the print head 25 in FIG. 2 is not intended to limit the present embodiments to any particular type of printing system, and should not be used to limit application or scope of the claims.

The ink of the present embodiments is designed for use in either a direct printing mode or an indirect or offset printing transfer system. In the direct printing mode, the ink in one embodiment contains one or more materials that allow the ink (1) to be applied in a thin film of uniform thickness on the final recording substrate (such as paper, transparency material, and the like) when cooled to ambient temperature after printing directly to the recording substrate, (2) to be ductile while retaining sufficient flexibility so that the applied image on the substrate will not fracture upon bending, and (3) to possess a high degree of lightness, chroma, transparency, and thermal stability. In an offset printing transfer or indirect printing mode, the ink in one embodiment exhibits not only the characteristics desirable for direct printing mode inks, but also certain fluidic and mechanical properties desirable for use in such a system, as described in, for example, U.S. Pat. No. 5,389,958 the disclosure of which is totally incorporated herein by reference.

In FIG. 2, a leveling device 40 is placed in-line within the print process following ink transfer and preceding the UV curing station 65. In particular, the leveling device 40 can be an acoustic or ultrasound horn which provides a source of ultrasound irradiation to level the unleveled ink film or print image 45. In embodiments, an optional second leveling device 50 may be included in the printing system 55. The secondary leveling device 50 may be mounted beneath the substrate or web 35 for additional leveling forces underneath the substrate if desired. The secondary leveling device 50 may also be located somewhere downstream from the primary leveling device 40. The leveling device 40 and secondary leveling device 50, if included, subject the unleveled ink film or print image 45 to ultrasonic waves. Thereafter, the leveled ink film or print image 60 is then cured at an UV curing station 65 to form the final cured ink film or print image 70. The UV light dispensed at the curing station may be light having a wavelength of from about 200 to about 400 nanometers, visible light, electron beam energy or the like. The curing step may be applied inline through any UV light source such as a mercury lamp, UV curing lamp, xenon lamp, laser light, D or H bulb, or light-emitting diodes (LED). The curing light may be filtered, if desired or necessary. In embodiments, the curing step may also be conducted offline using a 600 W Fusion UV Systems Inc. Lighthammer equipped with a D-bulb.

The curing step need not be long, and may be for, for example, from about 0.05 to about 10 seconds, more preferably from about 0.1 to about 5 seconds. These radiation exposure times are more often expressed as substrate speeds of the ink passing under a UV lamp. For example, the microwave energized, doped mercury bulbs available from Fusion UV Systems (Gaithersburg, Md.) are placed in an elliptical mirror assembly that is 10 cm wide; multiple units may be placed in series. Thus, a belt speed of 0.1 ms⁻¹ would require 1 second for a point of an image to pass under a single unit, while a belt speed 4.0 ms⁻¹ would require 0.2 s to pass under four bulb assemblies. The curable components of the ink react to form a cured or crosslinked network of appropriate hardness. Preferably, the curing is substantially complete, i.e., at least 75% of the curable components are cured (polymerized and/or crosslinked), to allow the ink to be substantially hardened, and thereby to be much more scratch resistant, and also to adequately control the amount of showthrough on the substrate.

Any suitable substrate or recording sheet can be employed in the present systems and methods, including plain papers such as XEROX 4200 papers, XEROX Image Series papers, Courtland 4024 DP paper, ruled notebook paper, bond paper, silica coated papers such as Sharp Company silica coated paper, JuJo paper, HAMMERMILL LASERPRINT paper, and the like, glossy coated papers such as XEROX Digital Color Gloss, Sappi Warren Papers LUSTROGLOSS, specialty papers such as Xerox DURAPAPER, and the like, transparency materials, fabrics, textile products, plastics, polymeric films, inorganic recording mediums such as metals and wood, and the like, transparency materials, fabrics, textile products, plastics, polymeric films, inorganic substrates such as metals and wood, and the like.

The inks described herein are further illustrated in the following examples. All parts and percentages are by weight unless otherwise indicated.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

While the description above refers to particular embodiments, it will be understood that many modifications may be made without departing from the spirit thereof. The accompanying claims are intended to cover such modifications as would fall within the true scope and spirit of embodiments herein.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

### EXAMPLES

The example set forth herein below is illustrative of different compositions and conditions that can be used in practicing the present embodiments. All proportions are by weight unless otherwise indicated. It will be apparent, however, that the embodiments can be practiced with many types of compositions and can have many different uses in accordance with the disclosure above and as pointed out hereinafter.

### Prophetic Example #1

This prophetic example describes an experiment to demonstrate the feasibility of the present embodiments.

Ink Formulation #1

An UV-curable gel ink formulation is prepared according to Table 1 by combining the components in a 600 mL beaker heated to 90° C. in a heating mantle, and homogenized using a T-25 homogenizer probe (IKA) for 45 minutes.

TABLE 1

| Component | Wt % |
|---|---|
| Amide gellant | 7.5% |
| Unilin 350 acrylate | 5% |
| SR9003 | 54.8% |
| SR399LV (dipentaerythritol | 5% |
| pentaacrylate) | |
| Irgacure 379 | 3% |
| Irgacure 127 | 3.5% |
| Irgarcure 819 | 1% |
| Irgastab UV10 | 0.2% |
| 15 wt % cyan pigment | 20% |
| dispersion/SR9003 | |
| TOTAL | 100% |

Ink Characterization

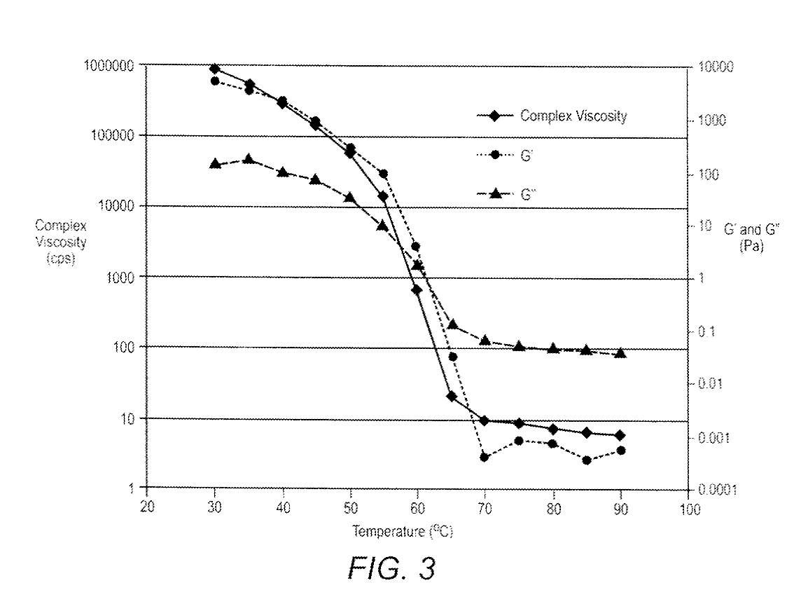

The ink formulation described in Example #1 is characterized by measurement of the rheology using a controlled-strain rheometer from TA Instruments (Rheometrics RFS-3). A temperature sweep from 90° C. to 30° C. at 1 Hz sweep rate in conducted with measurements every five degrees. FIG. 3 illustrates complex viscosity (y-axis, centipoise) versus temperature (x-axis, ° C.) for the exemplary ink.

Print and Leveling

Ink #1 is printed onto a sheet of Xerox Digital Colour Elite Gloss Paper using a Maverick printhead on a Xerox phaser printer, modified to be used in a direct-to-paper architecture. The paper substrate with unleveled ink coating is placed on a moving conveyer belt operating at 5 fpm passing under an in-line ultrasonic horn angled at 45° with respect to the paper path, operating at a horn frequency of 20,000 kHz and a peak-to-peak amplitude of 0.3 mm

Curing

The printed and leveled ink film is passed through a Fusions UV Lighthammer® available from Fusions UV Systems, Inc., equipped with a 600 W mercury D-bulb at a variety of conveyor belt speeds including 10 feet per minute (fpm), 32 fpm, 90 fpm, 150 fpm, and 230 fpm.

All the patents and applications referred to herein are hereby specifically, and totally incorporated herein by reference in their entirety in the instant specification.

It will be appreciated that several of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

1. A method for leveling a phase change gel ink comprising:
applying the phase change gel ink on a substrate to form an unleveled ink film; and
subjecting the unleveled ink film to ultrasound irradiation to form a leveled ink film.

2. The method of claim 1 further including curing the leveled ink film.

3. The method of claim 2, wherein the curing step is performed by a source selected from the group consisting of an ultraviolet curing lamp, mercury lamp, xenon lamp, laser light, D or H bulb, or light-emitting diodes (LED) and mixtures thereof.

4. The method of claim 2, wherein the curing step is performed for about 0.1 to about 5 seconds.

5. The method of claim 1, wherein the unleveled ink film is subjected to the ultrasound irradiation by an ultrasonic transducer.

6. The method of claim 1, wherein the unleveled ink film is subjected to the ultrasound irradiation for about 0.1 to about 60 seconds.

7. The method of claim 1, wherein the unleveled ink film is subjected to the ultrasound irradiation at an intensity of from about 5 to about 100 W.

8. The method of claim 1, wherein the unleveled ink film is subjected to the ultrasound irradiation at a frequency of from about 20,000 to about 30,000 Hz.

9. The method of claim 1, wherein the unleveled ink film is subjected to the ultrasound irradiation having from about 0.01 to about 0.5 mm peak-peak amplitude.

10. The method of claim 1, wherein the leveled ink film is uniform in thickness and has a thickness of from about 0.5 to about 100 μm.

11. The method of claim 1, wherein phase change gel ink is applied by jetting from an inkjet print head.

12. The method of claim 1, wherein the ink film is a printed image.

13. The method of claim 1, wherein the phase change gel ink is ultraviolet curable.

14. A system for leveling a phase change gel ink comprising:
a print head for transferring the phase change gel ink to a substrate to form an unleveled ink film;
a leveling device for subjecting the unleveled ink film to ultrasound irradiation to form a leveled ink film; and
a curing station for curing the leveled ink film.

15.-20. (canceled)

21. The method of claim 1, wherein the phase change gel ink has a viscosity of from about 5 to about 20 mPa-s at a jetting temperature of from about 80° C. to about 110° C., and a viscosity of from 10⁴ mPa-s to about 10⁹ mPa-s at a lower temperature of from about 20° C. to about 60° C.
